(19) United States
(12) Patent Application Publication
(10) Pub. No.: US 2026/0307383 A1
(43) Pub. Date: Oct. 8, 2026

(54) LIQUID DISCHARGE HEAD SUBSTRATE, LIQUID DISCHARGE HEAD, AND LIQUID DISCHARGE APPARATUS

(71) Applicant: CANON KABUSHIKI KAISHA, Tokyo (JP)

(72) Inventors: AKIRA OSETO, Chiba (JP); MAKOTO TAKAGI, Kanagawa (JP); YASUHIRO OGURO, Chiba (JP); YASUSHI NAKATA, Kanagawa (JP)

(21) Appl. No.: 19/462,114

(22) Filed: Jan. 28, 2026

(30) Foreign Application Priority Data
Jan. 29, 2025 (JP) 2025-013212

(51) Int. Cl. B41J 2/045

(52) U.S. Cl. CPC B41J 2/04543; B41J 2/04548; B41J 2/04573; B41J 2/0458

(57) ABSTRACT

A liquid discharge head substrate including a first line connected to drivers that drive discharge elements in first and second groups, a second line connected to drivers that drive discharge elements in third and fourth groups, first and second delay elements arranged on the first line, and third and fourth delay elements arranged on the second line is provided. An output of the first, second, third and fourth delay elements are supplied to the drivers that drive the discharge elements in the first, second, third and fourth groups, respectively. A number of discharge elements in the first group is larger than that in the second group, a number of discharge elements in the third group is larger than that in the fourth group, and the discharge elements in the first and third groups are not driven simultaneously.

### BACKGROUND

### Field of the Technology

The present disclosure relates to a liquid discharge head substrate, a liquid discharge head, and a liquid discharge apparatus.

### Description of the Related Art

In a liquid discharge head substrate, if a plurality of liquid discharge elements are simultaneously driven, a large current flows to a power supply line and a ground line. In the rise and fall of the large current, electromagnetic noise is generated by induction coupling between the power supply line and the ground line and an operation error may occur in a logic circuit arranged on the liquid discharge head substrate. Japanese Patent Laid-Open No. 2008-273177 shows that, to reduce electromagnetic noise, liquid discharge elements are divided into a plurality of groups, and the timing to drive is shifted for each group, thereby decreasing the number of liquid discharge elements to simultaneously start driving and making the change of the current per unit time small.

To cause the liquid discharge head substrate to operate at a high speed, as many liquid discharge elements as possible need to be simultaneously driven. As shown in Japanese Patent Laid-Open No. 2008-273177, if liquid discharge elements are divided into a plurality of groups, each group needs to include a predetermined number of liquid discharge elements or more. If liquid discharge elements are divided into a plurality of groups under such a restriction, there is a possibility that it is not possible to make the number of liquid discharge elements included in each group uniform.

### SUMMARY

Some embodiments of the present disclosure provide a technique advantageous in reducing electromagnetic noise when driving liquid discharge elements in a case where the number of liquid discharge elements included in each group cannot be made to be uniform.

According to some embodiments, a liquid discharge head substrate comprising a plurality of liquid discharge elements divided into a plurality of groups; a first control signal line connected to driving elements that drive liquid discharge elements included in a first group and a second group of the plurality of groups; a second control signal line connected to driving elements that drive liquid discharge elements included in a third group and a fourth group of the plurality of groups; a first delay circuit including a first delay element and a second delay element arranged on a path of the first control signal line; and a second delay circuit including a third delay element and a fourth delay element arranged on a path of the second control signal line, wherein an output of the first delay element is supplied to the driving elements that drive the liquid discharge elements included in the first group, an output of the second delay element is supplied to the driving elements that drive the liquid discharge elements included in the second group, an output of the third delay element is supplied to the driving elements that drive the liquid discharge elements included in the third group, an output of the fourth delay element is supplied to the driving elements that drive the liquid discharge elements included in the fourth group, a number of liquid discharge elements included in the first group is larger than a number of liquid discharge elements included in the second group, a number of liquid discharge elements included in the third group is larger than a number of liquid discharge elements included in the fourth group, and the liquid discharge elements included in the first group and the liquid discharge elements included in the third group are arranged at positions where the liquid discharge elements are not driven simultaneously, is provided.

Features of the present disclosure will become apparent from the following description of embodiments with reference to the attached drawings. The following description of embodiments is described by way of example.

### BRIEF DESCRIPTION OF THE DRAWINGS

FIG. 1 is a view showing an example of the configuration of a liquid discharge head substrate;

FIG. 2 is a view showing an example of the configuration of one group of liquid discharge elements of the liquid discharge head substrate;

FIG. 3 is a timing chart showing an example of driving of a group;

FIG. 4 is a timing chart showing an example of driving of the liquid discharge head substrate;

FIG. 5 is a timing chart showing an example of driving of the liquid discharge head substrate;

FIG. 6 is a view showing an example of the configuration of the liquid discharge head substrate;

FIG. 7 is a timing chart showing an example of driving of the liquid discharge head substrate;

FIG. 8 is a timing chart showing an example of driving of the liquid discharge head substrate;

FIG. 9 is a timing chart showing an example of driving of the liquid discharge head substrate;

FIG. 10 is a view showing an example of the configuration of one group liquid discharge elements of the liquid discharge head substrate;

FIG. 11 is a view showing an example of the configuration of the liquid discharge head substrate; and

FIGS. 12A to 12D are views showing an example of the configuration of a liquid discharge apparatus using the liquid discharge head substrate.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

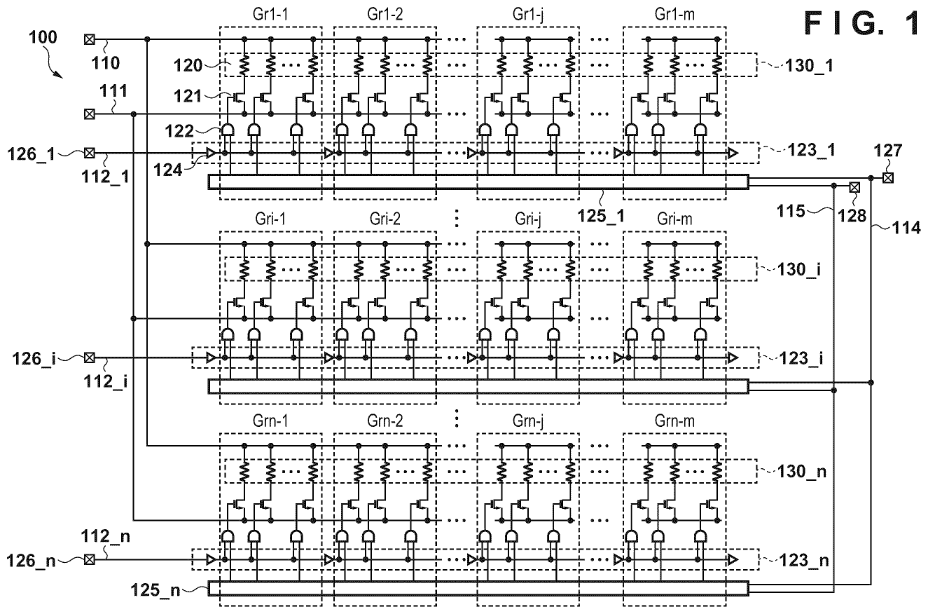

A liquid discharge head substrate according to the embodiment of the present disclosure will be described with reference to FIGS. 1 to 11. FIG. 1 is a circuit diagram showing an example of the configuration of a liquid discharge head substrate 100 according to this embodiment. FIG. 1 shows resistors functioning as liquid discharge elements 120 on the liquid discharge head substrate 100, and driving circuits that drive the liquid discharge elements 120. Each liquid discharge element 120 may be a resistor that converts electric energy into thermal energy, as shown in FIG. 1, or may be, for example, a piezoelectric element that converts electric energy into mechanical energy.

In the configuration shown in FIG. 1, the plurality of liquid discharge elements 120 are divided into n×m group Gri-j (i and j are integers satisfying 1≤i≤n and 1≤j≤m). n is the number of divisions in the vertical direction in FIG. 1 and indicates the number of liquid discharge element arrays 130_i each including a plurality of groups arranged in the horizontal direction in FIG. 1. m indicates the number of groups Gr included in one liquid discharge element array 130_i. That is, the liquid discharge element array 130_i includes groups Gri-1 to Gri-m. In FIG. 1, the number of groups Gr included in the liquid discharge element array 130_i is m in all liquid discharge element arrays, but the number of groups Gr may change between the liquid discharge element arrays 130_i.

FIG. 1 also shows an example in which the plurality of liquid discharge element arrays 130_i (i>3) are arranged. However, the present disclosure is not limited to this, and i≥2 suffices to obtain the effect of the present disclosure. When the plurality of liquid discharge element arrays 130_i are used, for example, it may be easy to discharge inks of a plurality of colors using a single liquid discharge head.

The plurality of liquid discharge elements 120 are arranged between common power supply lines 110 and 111. The power supply line 110 is commonly connected to one-end sides of the liquid discharge elements 120. In each liquid discharge element 120, the other-end side of the liquid discharge element 120 is connected to the drain terminal of a transistor used as a driving element 121. The source terminal of the transistor used as the driving element 121 is commonly connected to the power supply line 111. Appropriate potentials are supplied to the power supply lines 110 and 111 via external connecting terminals. For example, the power supply line 110 may be a power supply line configured to supply a power supply potential, and the power supply line 111 may be a power supply line configured to supply the ground potential.

In the configuration shown in FIG. 1, the power supply lines 110 and 111 are common to all groups Gr, but, for example, the power supply lines may be different for each liquid discharge element array 130_i or may be different for each group Gr included in the liquid discharge element array 130_i. However, if the power supply lines 110 and 111 are common to all groups Gr, a current flows to the same power supply lines 110 and 111 when the liquid discharge elements 120 are driven and, therefore, electromagnetic noise readily occurs between the power supply lines 110 and 111. It is therefore possible to obtain a large effect of the present disclosure to be described later.

Control signal lines 112 in each of which a terminal 126 to which an enable signal that defines the drive timings of the plurality of liquid discharge elements 120 is supplied, and a plurality of delay elements 124 that delay propagation of the enable signal are arranged are arranged on the liquid discharge head substrate 100. The plurality of delay elements 124 arranged on the path of each control signal line 112 form a delay circuit 123. The delay circuit 123 is a circuit configured to delay the enable signal that defines the drive timings of the liquid discharge elements 120. The enable signal is a signal for turning on (conducting) the driving element 121 for driving the liquid discharge element 120 and is supplied from the terminal 126 to the delay circuit 123 via the control signal line 112. In the configuration shown in FIG. 1, a control signal line 112_i includes a delay circuit 123_i, and defines the drive timings of the liquid discharge elements 120 included in the liquid discharge element array 130_i. It can also be said that one control signal line 112_i corresponds to one liquid discharge element array 130_i. However, the present disclosure is not limited to this configuration, and the control signal line 112 may be shared by two or more liquid discharge element arrays 130_i.

The delay circuit 123_i is formed by connecting a plurality of delay elements 124_i-j in series, and defines the drive timing of the liquid discharge element array 130_i. Also, the output of the delay element 124_i-j is supplied to the liquid discharge elements 120 included in the group Gri-j via the control gate circuits 122 and the driving elements 121 and defines the drive timings of the liquid discharge elements 120 included in the group Gri-j.

The liquid discharge head substrate 100 can include memory circuits 125 and the like in addition to the driving elements 121 and the control gate circuits 122. The driving element 121 controls drive or non-drive of the liquid discharge element 120. In this embodiment, an NMOS transistor is used as the driving element 121. However, the present disclosure is not limited to this and, for example, a PMOS transistor may be used. The control gate circuit 122 controls the gate voltage of the transistor that is the driving element 121. The memory circuit 125 is a circuit that holds information of drive or non-drive of each liquid discharge element 120. A delayed enable signal that is the output of the delay circuit 123 and a selection signal that is the output of the memory circuit 125 are supplied to the control gate circuit 122. In accordance with the output of the control gate circuit 122, which is the operation result between the enable signal and the selection signal supplied to the control gate circuit 122, a specific driving element 121 is turned on, and the liquid discharge element 120 is driven. A selection signal according to a data signal supplied by a data signal line 115 is transferred to the memory circuit 125 by a clock signal (not shown). The selection signal is stored in a memory in the memory circuit 125 in accordance with a memory timing signal supplied by a memory timing signal line 114. The memory timing signal and the data signal are supplied from the outside of the liquid discharge head substrate 100 via terminals 127 and 128.

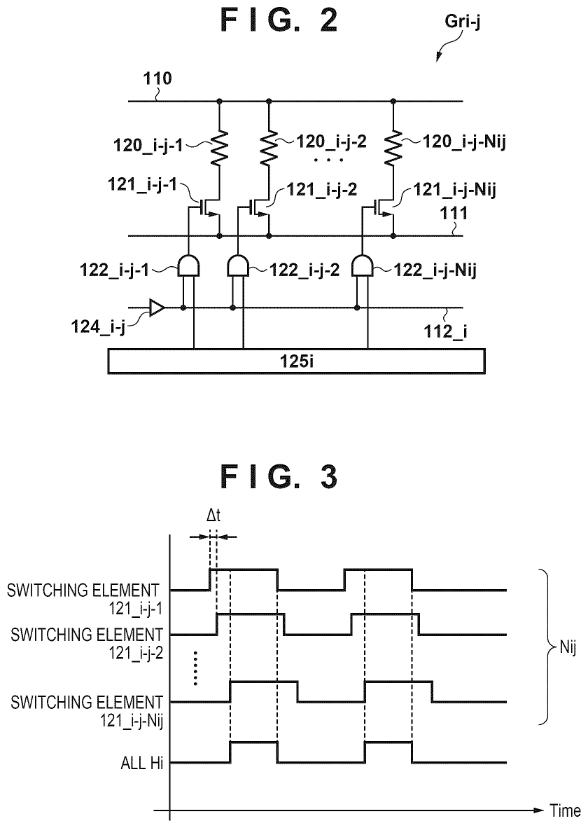

FIG. 2 is a circuit diagram showing one group Gri-j of the plurality of groups Gr shown in FIG. 1 in an enlarged state. The group Gri-j includes Nij liquid discharge elements 120, and liquid discharge elements 120_i-j-1 to 120_i-j-Nij are connected to the control signal line 112_i and the memory circuit 125_i via driving elements 121_i-j-1 to 121_i-j-Nij and control gate circuits 122_i-j-1 to 122_i-j-Nij with the same indices, respectively. The drive timing of each group Gr can be controlled by the output of a corresponding one of the plurality of delay elements 124 arranged in the delay circuit 123. For example, as shown in FIG. 2, the drive timing of the driving element 121_i-j arranged in the group Gri-j is controlled by the output of the delay element 124_i-j.

FIG. 3 is a timing chart showing the timings of turning on the driving elements 121_i-j-1 to 121_i-j-Nij included in the group Gri-j shown in FIG. 2. More specifically, FIG. 3 shows the timing at which the enable signal is supplied from the delay element 124_i-j to the control gate circuit 122 and the driving elements 121_i-j-1 to 121_i-j-Nij can be turned on. The driving element 121 is turned on (conducted) by the combination of the enable signal and the selection signal supplied to the control gate circuit 122. For the sake of simplicity, an explanation will be made here assuming that all driving elements 121 are selected.

As described above, the drive timing of the group Gri-j is defined by the delay amount of the delay element 124_i-j. However, even the driving elements 121_i-j-1 to 121_i-j-Nij included in the same group Gri-j are affected by the wiring resistance of the control signal line 112_i, and the like, resulting in differences in the delay amount. For example, the driving element 121_i-j-1 is turned on, and the driving element 121_i-j-2 is turned on next after the elapse of time Δt due to the influence of the wiring resistance. Similarly, the last driving element 121_i-j-Nij of the group Gri-j is turned on after the elapse of time Δt×Nij from the ON timing of the driving element 121_i-j-1. “ALL Hi” shown in FIG. 3 is the period in which all driving elements 121_i-j-1 to 121_i-j-Nij included in the group Gri-j are turned ON. As described above, when the driving element 121 is turned on, a current flows to the power supply lines 110 and 111 via the liquid discharge element 120, and the liquid discharge element 120 is driven.

In the liquid discharge head substrate 100 including the plurality of liquid discharge elements 120 divided into a plurality of groups as shown in FIG. 1, the number of liquid discharge elements 120 included in each group may be different between the groups Gr. For example, due to reasons on the design of wiring patterns and the like formed on the liquid discharge head substrate 100, the number of liquid discharge elements 120 included in some groups Gr may be larger or smaller than in other groups Gr. Driving of the liquid discharge head substrate 100 according to this embodiment in a case where the number of liquid discharge elements 120 included in each group cannot be made to be uniform will be described next.

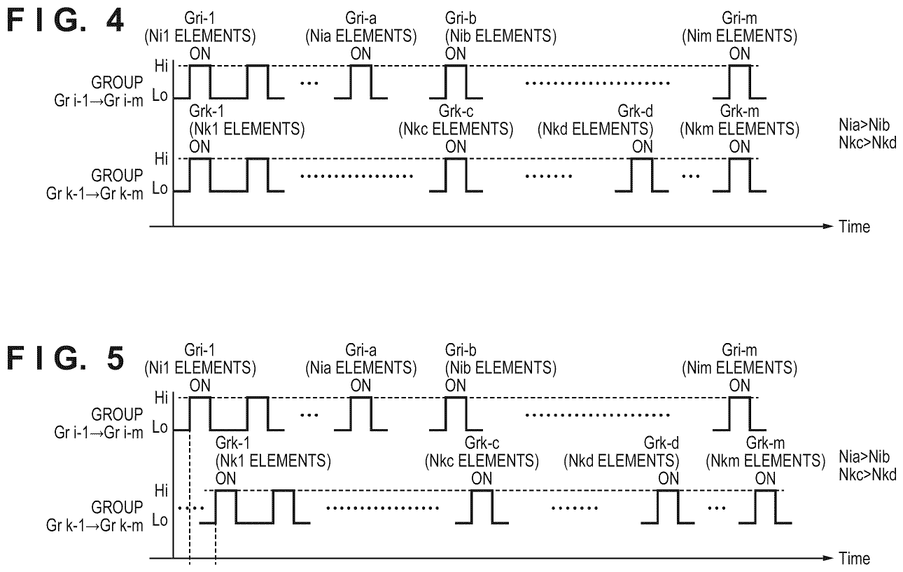

FIG. 4 is a timing chart showing timings at which the liquid discharge elements 120 included in groups Gri-1 to Gri-m arranged in the liquid discharge element array 130_i and groups Grk-1 to Grk-m arranged in a liquid discharge element array 130_k are driven. The liquid discharge element arrays 130_i and 130_k can be arbitrary element arrays of the liquid discharge element arrays 130_1 to 130_n shown in FIG. 1. In FIG. 4, a Hi period shown in the timing chart indicates the ALL Hi period in FIG. 3. That is, the Hi period shown in the timing chart indicates a period in which all driving elements 121 included in the groups Gr are turned on, and the liquid discharge elements 120 are driven.

The upper stage of FIG. 4 indicates a timing chart in the liquid discharge element array 130_i, and the lower stage indicates a timing chart in the liquid discharge element array 130_k. As described above, the timings of turning on the driving elements 121 in the group Gri-j arranged in the liquid discharge element array 130_i are defined by the delay amount of the delay element 124_i-j. Thus, the driving elements 121 are turned on in the order of groups Gri-1→Gri-m, and corresponding liquid discharge elements 120 are driven. Similarly, the timings of turning on the driving elements 121 in the group Grk-j arranged in the liquid discharge element array 130_k are defined by the delay amount of the delay element 124_k-j. Thus, the driving elements 121 are turned on in the order of groups Grk-1→Grk-m, and corresponding liquid discharge elements 120 are driven.

Also, the group Gri-j includes Nij liquid discharge elements 120, and groups Gri-a, Gri-b, Grk-c, and Grk-d include Nia, Nib, Nkc, and Nkd liquid discharge elements 120, respectively. Assume here that the number of liquid discharge elements 120 is not uniform in the groups Gri-a, Gri-b, Grk-c, and Grk-d. More specifically, in the groups Gri-a and Gri-b arranged in the same liquid discharge element array 130_i, the number of liquid discharge elements 120 included in the group Gri-a is larger than the number of liquid discharge elements 120 included in the group Gri-b (Nia>Nib). Similarly, in the groups Grk-c and Grk-d arranged in the same liquid discharge element array 130_k, the number of liquid discharge elements 120 included in the group Grk-c is larger than the number of liquid discharge elements 120 included in the group Grk-d (Nkc>Nkd).

In this case, in this embodiment, the liquid discharge elements 120 included in the group Gri-a and the liquid discharge elements 120 included in the group Grk-c are arranged at positions where these are not simultaneously driven. It can also be said that the driving elements 121 that drive the liquid discharge elements 120 included in the group Gri-a and the driving elements 121 that drive the liquid discharge elements 120 included in the group Grk-c are not turned on (arranged at positions where these are not turned on) simultaneously. That is, of two arbitrary groups Gr in the two arbitrary liquid discharge element arrays 130_i and 130_k, groups in which the number of liquid discharge elements 120 is large are not simultaneously driven. For example, the number of delay elements 124 arranged on the control signal line 112_i between the terminal 126_i and the delay element 124 configured to control the drive timings of the driving elements 121 that drive the liquid discharge elements 120 included in the group Gri-a and the number of delay elements 124 arranged on the control signal line 112_k between the terminal 126_k and the delay element 124 configured to control the drive timings of the driving elements 121 that drive the liquid discharge elements 120 included in the group Grk-c may be different. This implements the driving as described above.

Consider a case where the group Gri-a arranged in the liquid discharge element array 130_i and including a large number of liquid discharge elements 120 and the group Grk-c arranged in the liquid discharge element array 130_k and including a large number of liquid discharge elements 120 are simultaneously driven. In this case, the amount of the current flowing to the power supply line 110 increases, and electromagnetic noise associated with the current change in the power supply lines 110 and 111 may increase. By the configuration according to this embodiment, it is possible to decrease the number of liquid discharge elements 120 to be simultaneously driven and thus suppress generation of electromagnetic noise.

FIG. 4 shows that the liquid discharge elements 120 included in the group Gri-b and the liquid discharge elements 120 included in the group Grk-c are simultaneously driven. However, to obtain the effect of this embodiment, the configuration is not limited to this, and it suffices that the liquid discharge elements 120 included in the group Gri-a and the liquid discharge elements 120 included in the group Grk-c are not simultaneously driven.

FIG. 4 shows that, for example, the liquid discharge elements 120 of the groups Gri-j and Grk-j with the same index, for example, the group Gri-1 and the group Grk-1, are simultaneously driven. As described above, the timings at which the driving elements 121 of each group Gr are turned on and the liquid discharge elements 120 are driven are defined by the delay amount of the delay element 124_i-j. Hence, in FIG. 4, the delay amounts of the delay elements 124_i-j are the same in each liquid discharge element array 130_i. However, the present disclosure is not limited to this, and the delay elements 124_i-j with different delay amounts may be arranged in each liquid discharge element array 130_i.

FIG. 5 is a timing chart in a case where the delay amount of some delay elements 124_i-j is different from that of the remaining delay elements 124_i-j, unlike the timing chart shown in FIG. 4. If the delay element 124_i-j includes an inverter, the delay amount of the delay element 124_i-j can be adjusted by changing the number of stages of the inverter included in the delay element 124_i-j. For example, the delay amount is made larger only in the delay element 124_k-1 of the first stage arranged in the liquid discharge element array 130_k than in the delay element 124_k-j (j≠1) and the delay element 124_i-j. In this case, since the delay elements 124_k-1 to 124_k-m are connected in series, as shown in FIG. 5, the timings of driving (turning on) all liquid discharge elements 120_k (driving elements 121_k) included in the liquid discharge element array 130_k are shifted as a whole. With this configuration, the drive timings of the liquid discharge elements 120 included in the group Gri-j and the liquid discharge elements 120 included in the group Grk-j with the same index j can be shifted. As a result, the number of liquid discharge elements 120 to be simultaneously driven can be made smaller than in the configuration shown in FIG. 4. In FIG. 5, the delay amount is made larger only in the delay element 124_k-1 than in the remaining delay elements 124. However, the configuration is not limited to this, and the delay amount of a plurality of delay elements 124 may be changed. Also, for example, the delay amount of the delay element 124_k-1 may be adjusted such that it becomes smaller than the delay amount of the remaining delay elements 124.

In the configurations shown in FIGS. 4 and 5, each group Gr whose drive timing is controlled by the enable signal that propagates through one control signal line 112_i and is delayed by the delay element 124_i arranged there is driven at a different timing. This makes it possible to suppress the number of liquid discharge elements 120 to be simultaneously driven. However, the present disclosure is not limited to this, and there may be a period in which the liquid discharge elements 120 are driven simultaneously in two or more groups Gr. This can increase the speed of printing. Even in this case, as described above, it suffices that the liquid discharge elements 120 included in the group Gri-a and the liquid discharge elements 120 included in the group Grk-c are not simultaneously driven.

FIG. 6 is a view showing a modification of the liquid discharge head substrate 100 shown in FIG. 1. In the configuration shown in FIG. 1, one control signal line 112_i (delay circuit 123_i) is arranged in correspondence with one liquid discharge element array 130_i. In addition, the liquid discharge element arrays 130_i (the control signal lines 112_i and the delay circuits 123_i) each including two or more groups Gr and extending in the left/right direction of FIG. 1 are arranged side by side in the up/down direction of FIG. 1 crossing the direction in which the liquid discharge element arrays 130_i extend. On the other hand, in the liquid discharge head substrate 100 shown in FIG. 6, the liquid discharge elements 120 arranged in one liquid discharge element array 130_i are driven by the driving elements 121 connected to a plurality of control signal lines 112_i-p (delay circuits 123_i-p) (p≥2). Points different from the configuration shown in FIG. 1 will mainly be described below, and a description of components that can be the same will appropriately be omitted.

The liquid discharge element array 130_i shown in FIG. 6 includes m groups Gri-1 to Gri-m. Also, similar to the above, the number of liquid discharge elements 120 included in the group Gri-j is Nij, and the number of liquid discharge elements 120 included in the group Gr may be different depending on the group Gr. In the configuration shown in FIG. 6, there exists one liquid discharge element array 130_i (i=1), but a plurality of liquid discharge element arrays 130_i (i≥2) may be arranged.

In the configuration shown in FIG. 6, the driving elements 121 that drive the liquid discharge elements 120 included in the groups Gri-1 to Gri-h are connected to the delay circuit 123_i-1 arranged on the control signal line 112_i-1 via the control gate circuits 122. Similarly, the driving elements 121 that drive the liquid discharge elements 120 included in the groups Gri-(h+1) to Gri-m are connected to the delay circuit 123_i-2 arranged on the control signal line 112_i-2 via the control gate circuits 122. The delay circuits 123_i-1 and 123_i-2 formed by the plurality of delay elements 124 arranged on the paths of the control signal lines 112 define the timings at which the liquid discharge elements 120 (driving elements 121) included in the groups Gri-1 to Gri-h and Gri-(h+1) to Gri-m are driven (turned on). Similar to the above, the delay circuits 123_i-1 and 123_i-2 are formed by, for example, connecting the plurality of delay elements 124 in series.

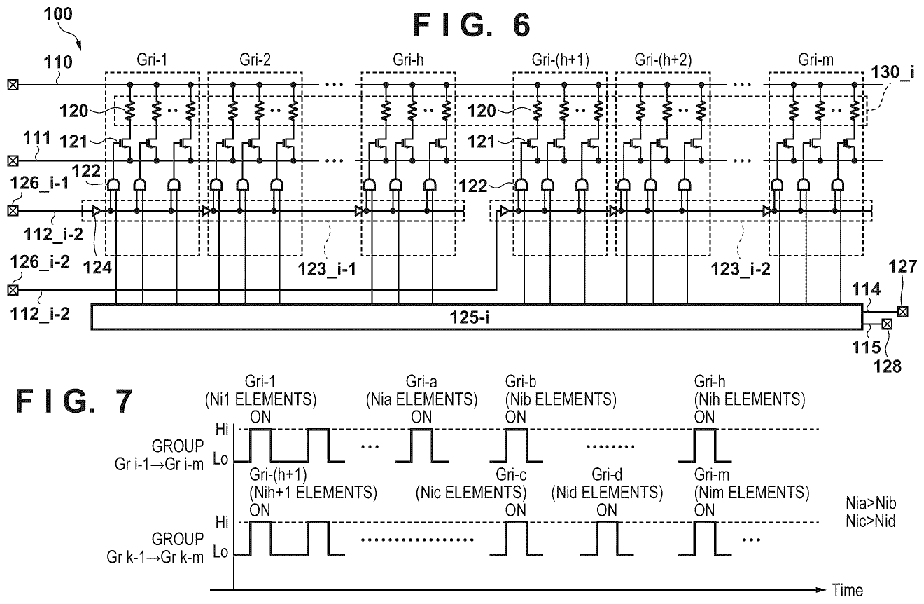

FIG. 7 is a timing chart showing timings at which the liquid discharge elements 120 included in the groups Gri-1 to Gri-m arranged in the liquid discharge element array 130_i shown in FIG. 6 are driven. In FIG. 7, a Hi period shown in the timing chart indicates the ALL Hi period in FIG. 3. That is, the Hi period shown in the timing chart indicates a period in which all driving elements 121 included in the groups Gr are turned on, and the liquid discharge elements 120 are driven.

The upper stage of FIG. 7 indicates a timing chart of the groups Gri-1 to Gri-h arranged in the liquid discharge element array 130_i, and the lower stage of FIG. 7 indicates a timing chart of the groups Gri-(h+1) to Gri-m arranged in the same liquid discharge element array 130_i. As described above, the timings of turning on the driving elements 121 that drive the liquid discharge elements 120 in the groups Gri-1 to Gri-h are defined by the delay amount of the delay element 124 arranged in the delay circuit 123_i-1. Thus, the driving elements 121 are turned on in the order of groups Gri-1→Gri-h, and corresponding liquid discharge elements 120 are driven. Similarly, the timings of turning on the driving elements 121 that drive the liquid discharge elements 120 in the groups Gri-(h+1) to Gri-m are defined by the delay amount of the delay element 124 arranged in the delay circuit 123_i-2. Thus, the driving elements 121 are turned on in the order of groups Gri-(h+1)→Gri-m, and corresponding liquid discharge elements 120 are driven.

Also, the group Gri-j includes Nij liquid discharge elements 120, and groups Gri-a, Gri-b, Gri-c, and Gri-d include Nia, Nib, Nic, and Nid liquid discharge elements 120, respectively. In this embodiment as well, assume that the number of liquid discharge elements 120 is not uniform in the groups Gri-a, Gri-b, Gri-c, and Gri-d. More specifically, in the groups Gri-a and Gri-b driven by the driving elements 121 connected to the same control signal line 112_i-1 (delay circuit 123_i-1), the number of liquid discharge elements 120 included in the group Gri-a is larger than the number of liquid discharge elements 120 included in the group Gri-b (Nia >Nib). Similarly, in the groups Gri-c and Gri-d driven by the driving elements 121 connected to the same control signal line 112_i-2 (delay circuit 123_i-2), the number of liquid discharge elements 120 included in the group Gri-c is larger than the number of liquid discharge elements 120 included in the group Gri-d (Nic>Nid).

In this case, in this embodiment, the liquid discharge elements 120 included in the group Gri-a and the liquid discharge elements 120 included in the group Gri-c are arranged at positions where these are not simultaneously driven. It can also be said that the driving elements 121 that drive the liquid discharge elements 120 included in the group Gri-a and the driving elements 121 that drive the liquid discharge elements 120 included in the group Gri-c are not turned on (arranged at positions where these are not turned on) simultaneously. That is, of the groups Gr to be driven by the driving elements 121 connected to the different control signal lines 112_i-1 (delay circuits 123_i-1), groups in which the number of liquid discharge elements 120 is large are not simultaneously driven. For example, the number of delay elements 124 arranged on the control signal line 112_i-1 between the terminal 126_i-1 and the delay element 124 configured to control the drive timings of the driving elements 121 that drive the liquid discharge elements 120 included in the group Gri-a and the number of delay elements 124 arranged on the control signal line 112_i-2 between the terminal 126_i-2 and the delay element 124 configured to control the drive timings of the driving elements 121 that drive the liquid discharge elements 120 included in the group Gri-c may be different. By using this configuration, it is possible to decrease the number of liquid discharge elements 120 to be simultaneously driven and thus suppress generation of electromagnetic noise.

FIG. 7 shows that the liquid discharge elements 120 included in the group Gri-b and the liquid discharge elements 120 included in the group Gri-c are simultaneously driven. However, to obtain the effect of this embodiment, the configuration is not limited to this, and it suffices that the liquid discharge elements 120 included in the group Gri-a and the liquid discharge elements 120 included in the group Gri-c are not simultaneously driven.

FIG. 7 shows a configuration in a case where, for example, the delay elements 124 arranged on the control signal lines 112_i-1 and 112_i-2 have the same delay amount so that the liquid discharge elements 120 included in the group Gri-1 and the group Gri-(h+1) are simultaneously driven. However, as in the relationships shown in FIGS. 4 and 5 described above, the delay amount of some delay elements 124 may be different from that of the remaining delay elements 124. Thus, the drive timings of the groups Gri-1 to Gri-h driven by the driving elements 121 connected to the control signal line 112_i-1 and the drive timings of the groups Gri-(h+1) to Gri-m driven by the driving elements 121 connected to the control signal line 112_i-2 may be shifted.

As described above, to perform high-speed print using the liquid discharge head substrate 100, as many liquid discharge elements 120 as possible need to be simultaneously driven. For example, the number of liquid discharge elements 120 included in each group Gr needs to be limited to a predetermined number or more. In the liquid discharge head substrate 100 having a long print length, the number of liquid discharge elements 120 included in the liquid discharge element array 130_i is large, and for a high-speed operation, a plurality of control signal lines 112_i-p (delay circuits 123_i-p) are sometimes arranged in correspondence with one liquid discharge element array 130_i. Even in this configuration, by using this configuration according to this embodiment, it is possible to decrease the number of liquid discharge elements 120 to be simultaneously driven and thus suppress generation of electromagnetic noise.

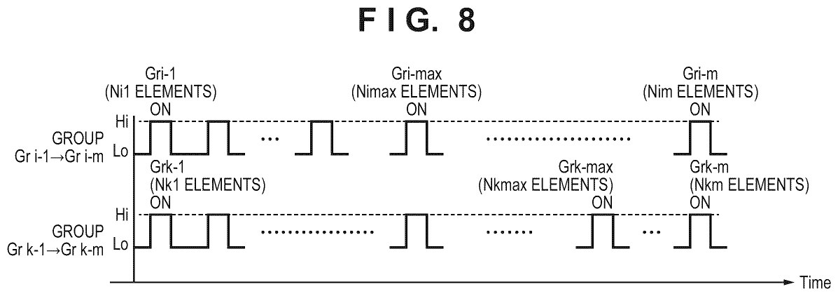

FIG. 8 is a timing chart showing a modification of the timing chart shown in FIG. 4, which shows the timings of driving, for example, in the configuration shown in FIG. 1, the liquid discharge elements 120 included in the groups Gri-1 to Gri-m and the groups Grk-1 to Grk-m. In FIG. 8 as well, a Hi period shown in the timing chart indicates the ALL Hi period in FIG. 3. That is, the Hi period shown in the timing chart indicates a period in which all driving elements 121 included in the groups Gr are turned on, and the liquid discharge elements 120 are driven.

A group Gri-max shown in FIG. 8 indicates a group in which the number of included liquid discharge elements 120 is largest in the groups Gri-1 to Gri-m. In the group Gri-max, Nimax liquid discharge elements 120 are arranged. Similarly, a group Grk-max indicates a group in which the number of included liquid discharge elements 120 is largest in the groups Grk-1 to Grk-m. In the group Grk-max, Nkmax liquid discharge elements 120 are arranged.

In the configuration shown in FIG. 8, the liquid discharge elements 120 included in the group Gri-max and the liquid discharge elements 120 included in the group Grk-max are arranged at positions where these are not simultaneously driven. It can also be said that the driving elements 121 that drive the liquid discharge elements 120 included in the group Gri-max and the driving elements 121 that drive the liquid discharge elements 120 included in the group Grk-max are not turned on (arranged at positions where these are not turned on) simultaneously. That is, in each liquid discharge element array 130_i, the groups Gr in which the number of liquid discharge elements 120 is largest are not simultaneously driven.

In the above-described drive timings, in the groups Gr arranged on two arbitrary liquid discharge element arrays 130_i, the groups in which the number of included liquid discharge elements 120 is large are inhibited from being simultaneously driven, thereby suppressing electromagnetic noise. On the other hand, as for the condition under which the electromagnetic noise is maximum, it is highly likely that the electromagnetic noise will be maximized when in the groups Gr arranged on the liquid discharge element arrays 130_i, the groups Gr in which the number of liquid discharge elements 120 is largest are simultaneously driven, although it depends on the circuit design. The driving condition that may maximize electromagnetic noise can be avoided by performing driving as shown in FIG. 8.

In FIG. 8, the drive timing has been described concerning the configuration including the plurality of liquid discharge element arrays 130_i, as shown in FIG. 1. However, the present disclosure is not limited to this, and the drive timing shown in FIG. 8 can be applied even to the configuration in which the plurality of control signal line 112_i-p (delay circuits 123_i-p) are arranged on one liquid discharge element array 130_1-p, as shown in FIG. 6. For example, in FIG. 8, the groups Gri-1 to Gri-m are replaced with the groups Gri-1 to Gri-h, and the groups Grk-1 to Grk-m are replaced with the groups Gri-(h+1) to Gri-m. This shows the drive timing in the configuration shown in FIG. 6.

FIG. 8 shows a configuration in which all delay elements 124 arranged on the path of each control signal line 112_i (delay circuit 123_i) have the same delay amount. However, as in the relationships shown in FIGS. 4 and 5 described above, the delay amount of some delay elements 124 may be different from that of the remaining delay elements 124.

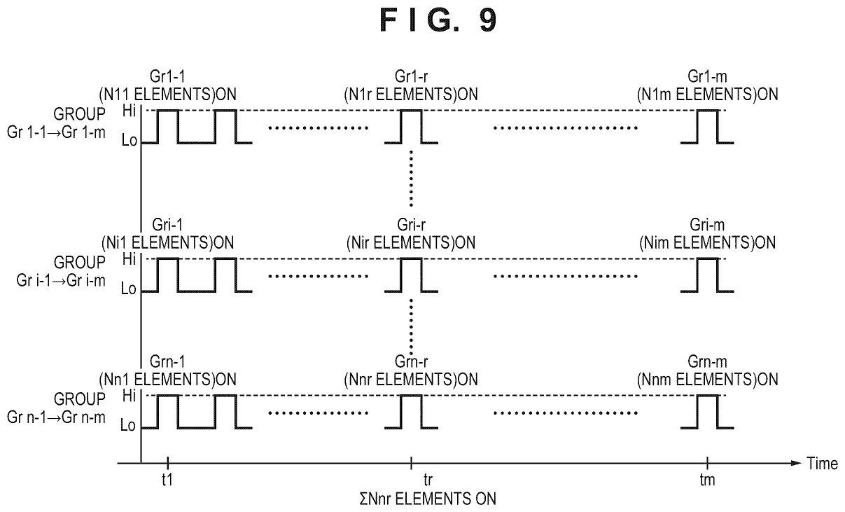

FIG. 9 is a timing chart showing a modification of the above-described driv timing. In FIG. 9 as well, a Hi period shown in the timing chart indicates the ALL Hi period in FIG. 3. That is, the Hi period shown in the timing chart indicates a period in which all driving elements 121 included in the groups Gr are turned on, and the liquid discharge elements 120 are driven.

The upper stage of FIG. 9 indicates a timing chart of the liquid discharge elements 120 included in the group Gr1-j, the middle stage indicates a timing chart of the liquid discharge elements 120 included in the group Gri-j, and the lower stage indicates a drive timing chart of the liquid discharge elements 120 included in the group Grn-j. For example, groups Gr1-j, Gri-j, and Grn-j may form liquid discharge element arrays 130_1, 130_i, and 130_n as shown in FIG. 1, respectively. Also, for example, the groups Gr1-j, Gri-j, and Grn-j may form one liquid discharge element array 130_i as shown in FIG. 6. In this case, the groups Gr1-j, Gri-j, and Grn-j include the liquid discharge elements 120 to be driven by the driving elements 121 connected to different control signal lines 112_i-1, 112_i-i, and 112_i-n. Furthermore, for example, the groups Gr1-j and Gri-j may form the same liquid discharge element array 130, and the group Grn-j may form the liquid discharge element array 130 different from that of the groups Gr1-j and Gri-j. Even in this case, the groups Gr1-j, Gri-j, and Grn-j include the liquid discharge elements 120 to be driven by the driving elements 121 connected to the different control signal lines 112_i-1, 112_i-i, and 112_i-n.

In FIG. 9, the number of liquid discharge elements 120 to be simultaneously driven at arbitrary time tr is ΣNnr(=N1r+N2r+. . . +Nnr). Also, when t1≤tr≤tm, the maximum number of ΣNnr is defined as max(ΣNnr), the minimum number is defined as min(ΣNnr), and the average number is defined as ave(ΣNnr). Here, time t1 indicates the timing at which the liquid discharge elements 120 included in the group Gri-1 are driven, and time tm indicates timing at which the liquid discharge elements 120 included in the group Gri-m are driven.

In this embodiment, the difference between the average number ave(ΣNnr) of liquid discharge elements to be simultaneously driven in the plurality of liquid discharge elements 120 and the minimum number min(ΣNnr) is larger than the difference between the average number ave(ΣNnr) of liquid discharge elements 120 to be simultaneously driven in the plurality of liquid discharge elements 120 and the maximum number max(ΣNnr). That is, a relationship given by {ave(ΣNnr)−min(ΣNnr)}>{max(ΣNnr)−ave(Σ)} holds. This indicates that the maximum number max(ΣNnr) of liquid discharge elements 120 to be simultaneously driven is made closer to the average number ave(ΣNnr) in each period of time t1 to tm.

For example, in the drive timing shown in FIG. 8, the groups Gr in which the number of liquid discharge elements 120 is maximum in each liquid discharge element array 130 are not simultaneously driven. For example, when the configuration shown in FIG. 9 is added to this driving, it is possible to avoid not only the combination in which the groups Gr in which the number of included liquid discharge elements 120 is maximum are simultaneously driven, but also a combination in which the number of liquid discharge elements 120 to be simultaneously driven is large. This can more effectively suppress electromagnetic noise.

FIG. 9 also shows a configuration in which all delay elements 124 arranged on the path of each control signal line 112_i (delay circuit 123_i) have the same delay amount. However, as in the relationships shown in FIGS. 4 and 5 described above, the delay amount of some delay elements 124 may be different from that of the remaining delay elements 124.

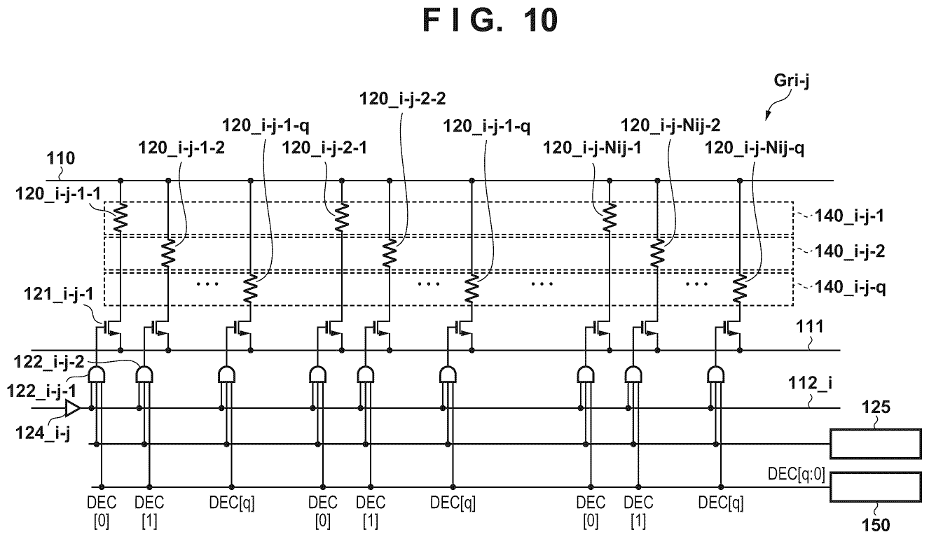

FIG. 10 shows a modification of the circuit diagram of one group Gri-j shown in FIG. 2. In the configuration shown in FIG. 10, a block selection logic circuit 150 is arranged as compared to the configuration shown in FIGS. 1 and 2. The block selection logic circuit 150 is a circuit configured to divide the liquid discharge elements 120 included in one group Gri-j into a plurality of blocks and time-divisionally drive these. The liquid discharge elements 120 arranged in one group Gri-j are divided into (q−1) (q≥3) blocks.

The block selection logic circuit 150 includes an output terminal that supplies block selection signals DEC[0] to DEC[q]. The block selection logic circuit 150 is controlled by block selection data (not shown), and the plurality of block selection signals DEC[0] to DEC[q] are never set in the enable state simultaneously. The block selection logic circuit 150 is configured to include, for example, a decoder and has a configuration capable of sequentially designating the liquid discharge elements 120 divided into a plurality of blocks on a block basis and driving (time-divisionally driving) these. To the control gate circuits 122, the block selection signals DEC[0] to DEC[q] that are the outputs of the block selection logic circuit 150 are supplied. In addition, to the control gate circuits 122, similar to the above, an enable signal delayed by the delay element 124_i-j is supplied from the control signal line 112_i, and a selection signal is supplied from the memory circuit 125.

In the configuration shown in FIG. 10, liquid discharge elements 120_1-j-1-1 to 120_i-j-Nij-q are divided into blocks 140_i-j-1 to 140_i-j-q. The liquid discharge elements 120_1-j-1-1 to 120_i-j-Nij-q are selected when the group Gri-j is selected by the enable signal and the block selection signal DEC[q] is set in the enable state. Hence, when the block selection signals DEC[0] to DEC[q] are sequentially supplied from the block selection logic circuit 150 during selection of the group Gri-j by the enable signal, the liquid discharge elements 120 included in the blocks 140_i-j-1 to 140_i-j-q are sequentially driven. In the configuration shown in FIG. 10, the plurality of liquid discharge elements 120 included in each group Gri-j are divided into blocks and sequentially driven. When the configuration shown in FIG. 10 is combined with each configuration described above, it is possible to decrease the number of liquid discharge elements 120 to be simultaneously driven and suppress generation of electromagnetic noise.

FIG. 11 is a plan layout diagram showing an example of the configuration one liquid discharge element array 130_i arranged on the liquid discharge head substrate 100 according to this embodiment. For example, as shown in FIG. 1, the groups Gri-j arranged on the liquid discharge element array 130_i may be formed by the liquid discharge elements 120 to be driven by the driving elements 121 connected to one control signal line 112_i. Also, for example, as shown in FIG. 6, the groups Gri-j arranged on the liquid discharge element array 130_i may include the groups Gr including the liquid discharge elements 120 to be driven by the driving elements 121 connected to different control signal lines 112_i.

In the configuration shown in FIG. 11, the liquid discharge element array 130_i is formed by the groups Gr_i_1 to Gr_i_m. The groups Gr_i_1 to Gr_i_m include Ni1 to Nim liquid discharge elements 120, respectively, and extend in the left/right direction of FIG. 11. Here, as shown in FIG. 11, the liquid discharge head substrate 100 may include a plurality of sub-heaters 160_i_1 to 160_i_m arranged along the liquid discharge element array 130_i. The sub-heater 160 is an element configured to heat the liquid to be discharged by the liquid discharge head substrate 100 or the liquid discharge elements 120 and keep it warm. In FIG. 11, the groups Gr_i_1 to Gr_i_m are arranged in portions corresponding to the heating regions of the sub-heaters 160_i_1 to 160_i_m. That is, each of the plurality of sub-heaters 160 is arranged in correspondence with one of the plurality of groups Gr. However, the present disclosure is not limited to this and, for example, a plurality of groups Gr may be arranged in a portion corresponding to the heating region of one sub-heater 160. Each of the plurality of sub-heaters 160 may be arranged in correspondence with one or more groups Gr of the plurality of groups Gr. To place focus on the sub-heaters 160, FIG. 11 shows only the arrangement of the liquid discharge elements 120 (groups Gr) and the sub-heaters 160, but the above-described components are arranged on the liquid discharge head substrate 100.

In the liquid discharge head substrate 100, to meet the requirement of improving image quality, the temperature of the liquid discharge head substrate 100 itself or the liquid to be discharged may be controlled. This is because in the liquid discharge head substrate 100, the droplet amount or discharge speed of the discharged liquid varies due to the influence of the temperature. When the liquid discharge head substrate 100 includes the sub-heaters 160, improvement of image quality of a liquid discharge apparatus using the liquid discharge head substrate 100 can be implemented.

The above-described components or drive timings can be used in combination. For example, the sub-heaters 160 shown in FIG. 11 make it possible to improve print image quality while suppressing the influence of electromagnetic noise in each driving described above. Thus, the liquid discharge head substrate 100 can implement higher performance even in a case where, when the plurality of liquid discharge elements 120 are divided into groups Gr, the number of liquid discharge elements 120 included in each group Gr cannot be made to be uniform.

### Other Embodiments

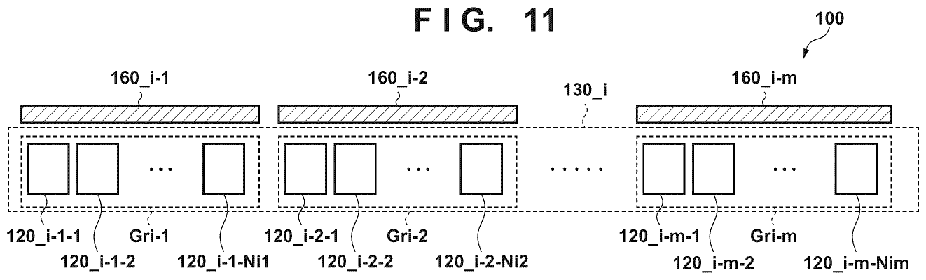

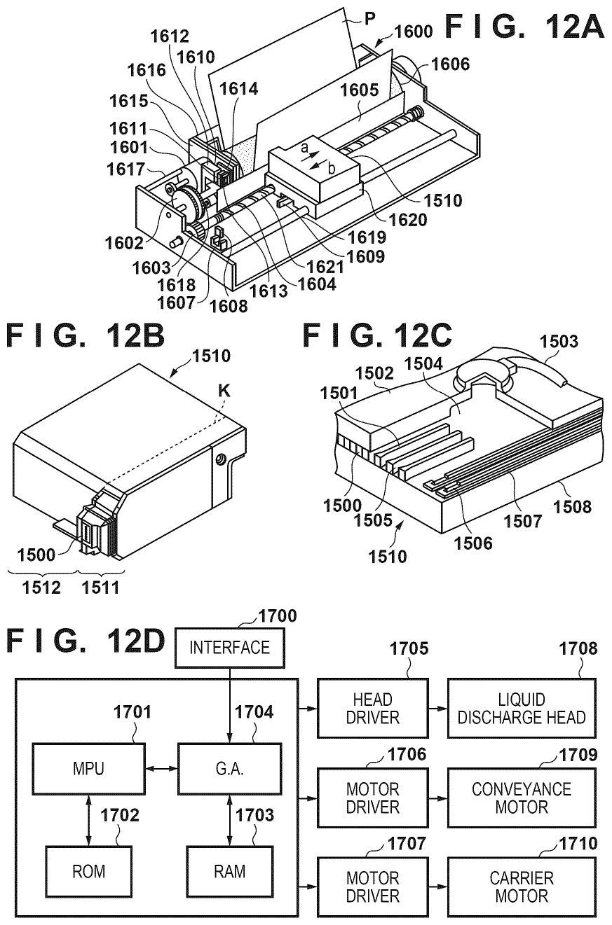

A liquid discharge apparatus using one of the above-described liquid discharge head substrate 100 will be explained here with reference to FIGS. 12A to 12D. FIG. 12A exemplifies the internal configuration of a liquid discharge apparatus 1600 typified by an inkjet printer, a facsimile apparatus, or a copying machine. In this example, the liquid discharge apparatus may also be called a printing apparatus. The liquid discharge apparatus 1600 includes a liquid discharge head 1510 that discharges a liquid (in this example, ink or a printing material) to a predetermined medium P (in this example, a print medium such as paper). In this example, the liquid discharge head may also be called a printhead. The liquid discharge head 1510 is mounted on a carriage 1620, and the carriage 1620 can be attached to a lead screw 1621 having a helical groove 1604. The lead screw 1621 can rotate in synchronization with rotation of a driving motor 1601 via driving force transmission gears 1602 and 1603. The liquid discharge head 1510 can move in a direction indicated by an arrow a or b along a guide 1619 together with the carriage 1620.

The medium P is pressed by a paper press plate 1605 in the carriage moving direction and fixed to a platen 1606. The liquid discharge apparatus 1600 performs liquid discharge (in this example, print) to the medium P conveyed on the platen 1606 by a conveyance unit (not shown) by reciprocating the liquid discharge head 1510.

The liquid discharge apparatus 1600 confirms the position of a lever 1609 provided on the carriage 1620 via photocouplers 1607 and 1608, and switches the rotational direction of the driving motor 1601. A support member 1610 supports a cap member 1611 for covering the nozzle (a liquid discharge port or simply a discharge port) of the liquid discharge head 1510. A suction portion 1612 performs recovery processing of the liquid discharge head 1510 by sucking the interior of the cap member 1611 via an intra-cap opening 1613. A lever 1617 is provided to start recovery processing by suction, and moves along with movement of a cam 1618 engaged with the carriage 1620. A driving force from the driving motor 1601 is controlled by a well-known transmission mechanism such as a clutch switch.

A main body support plate 1616 supports a moving member 1615 and a cleaning blade 1614. The moving member 1615 moves the cleaning blade 1614 to perform recovery processing of the liquid discharge head 1510 by wiping. The liquid discharge apparatus 1600 includes a controller (not shown) and the controller controls driving of each mechanism described above.

FIG. 12B exemplifies the outer appearance of the liquid discharge head 1510. The liquid discharge head 1510 can include a head portion 1511 having a plurality of nozzles 1500, and a tank (liquid storage portion) 1512 that holds a liquid to be supplied to the head portion 1511. The tank 1512 and the head portion 1511 can be separated at, for example, a broken line K and the tank 1512 is interchangeable. The liquid discharge head 1510 has an electrical contact (not shown) for receiving an electrical signal from the carriage 1620 and discharges a liquid in accordance with the electrical signal. The tank 1512 has a fibrous or porous liquid holding member (not shown) and the liquid holding member can hold a liquid.

FIG. 12C exemplifies the internal configuration of the liquid discharge head 1510. The liquid discharge head 1510 includes a base 1508, flow path wall members 1501 that are arranged on the base 1508 and form flow paths 1505, and a top plate 1502 having a liquid supply path 1503. The base 1508 may be the above-described liquid discharge head substrate 100. As discharge elements or liquid discharge elements, heaters 1506 (which can also be referred to as electrothermal transducers or heat generating resistive elements) are arrayed on the substrate (liquid discharge head substrate) of the liquid discharge head 1510 in correspondence with the respective nozzles 1500. Each heater 1506 is driven to generate heat by turning on a driving element (a driving element such as a transistor) provided in correspondence with the heater 1506.

A liquid from the liquid supply path 1503 is stored in a common liquid chamber 1504 and supplied to each nozzle 1500 via the corresponding flow path 1505. The liquid supplied to each nozzle 1500 is discharged from the nozzle 1500 in response to driving of the heater 1506 corresponding to the nozzle 1500.

FIG. 12D exemplifies the system configuration of the liquid discharge apparatus 1600. The liquid discharge apparatus 1600 includes an interface 1700, an MPU 1701, a ROM 1702, a RAM 1703, and a gate array (G.A.) 1704. The interface 1700 receives from the outside an external signal for executing liquid discharge. The ROM 1702 stores a control program to be executed by the MPU 1701. The RAM 1703 saves various signals and data such as the above-mentioned external signal for liquid discharge and data supplied to the liquid discharge head 1708. The gate array 1704 performs supply control of data to the liquid discharge head 1708 and control of data transfer between the interface 1700, the MPU 1701, and the RAM 1703.

The liquid discharge apparatus 1600 further includes a head driver 1705, motor drivers 1706 and 1707, a conveyance motor 1709, and a carrier motor 1710. The carrier motor 1710 conveys a liquid discharge head 1708. The conveyance motor 1709 conveys the medium P. The head driver 1705 drives the liquid discharge head 1708. The motor drivers 1706 and 1707 drive the conveyance motor 1709 and the carrier motor 1710, respectively.

When a driving signal is input to the interface 1700, it can be converted into data for liquid discharge between the gate array 1704 and the MPU 1701. Each mechanism performs a desired operation in accordance with this data. In this manner, the liquid discharge head 1708 is driven.

According to the present disclosure, it is possible to provide a technique advantageous in reducing electromagnetic noise when driving liquid discharge elements in a case where the number of liquid discharge elements included in each group cannot be made to be uniform.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-013212, filed Jan. 29, 2025, which is hereby incorporated by reference herein in its entirety.

What is claimed is:

1. A liquid discharge head substrate comprising:
a plurality of liquid discharge elements divided into a plurality of groups;
a first control signal line connected to driving elements that drive liquid discharge elements included in a first group and a second group of the plurality of groups;
a second control signal line connected to driving elements that drive liquid discharge elements included in a third group and a fourth group of the plurality of groups;
a first delay circuit including a first delay element and a second delay element arranged on a path of the first control signal line; and
a second delay circuit including a third delay element and a fourth delay element arranged on a path of the second control signal line,
wherein an output of the first delay element is supplied to the driving elements that drive the liquid discharge elements included in the first group,
an output of the second delay element is supplied to the driving elements that drive the liquid discharge elements included in the second group,
an output of the third delay element is supplied to the driving elements t drive the liquid discharge elements included in the third group,
an output of the fourth delay element is supplied to the driving elements that drive the liquid discharge elements included in the fourth group,
a number of liquid discharge elements included in the first group is larger than a number of liquid discharge elements included in the second group,
a number of liquid discharge elements included in the third group is larger than a number of liquid discharge elements included in the fourth group, and
the liquid discharge elements included in the first group and the liquid discharge elements included in the third group are arranged at positions where the liquid discharge elements are not driven simultaneously.

2. The substrate according to claim 1, wherein the liquid discharge head substrate comprises not less than one liquid discharge element array formed by not less than two groups of the plurality of groups, and
the liquid discharge elements included in each liquid discharge element array are arranged side by side in a first direction.

3. The substrate according to claim 2, wherein the not less than one liquid discharge element array includes a first liquid discharge element array including the liquid discharge elements included in the first group and the second group, and a second liquid discharge element array including the liquid discharge elements included in the third group and the fourth group, and
the first liquid discharge element array and the second liquid discharge element array are arranged side by side in a second direction crossing the first direction.

4. The substrate according to claim 2, wherein the not less than one liquid discharge element array includes a liquid discharge element array including the liquid discharge elements included in the first group, the second group, the third group, and the fourth group.

5. The substrate according to claim 1, wherein the plurality of liquid discharge elements are connected to the same power supply line.

6. The substrate according to claim 1, wherein the first delay element, the second delay element, the third delay element, and the fourth delay element include delay elements having different delay amounts.

7. The substrate according to claim 1, wherein driving elements that drive liquid discharge elements included in a first plurality of groups including the first group and the second group among the plurality of groups are connected to the first control signal line,
driving elements that drive liquid discharge elements included in a second plurality of groups including the third group and the fourth group among the plurality of groups are connected to the second control signal line, and
liquid discharge elements included in a group of the first plurality of groups in which the number of liquid discharge elements is maximum and liquid discharge elements included in a group of the second plurality of groups in which the number of liquid discharge elements is maximum are not simultaneously driven.

8. The substrate according to claim 1, wherein a difference between an average number of liquid discharge elements to be simultaneously driven in the plurality of liquid discharge elements and a minimum number is larger than a difference between the average number of liquid discharge elements to be simultaneously driven in the plurality of liquid discharge elements and a maximum number.

9. The substrate according to claim 1, wherein the liquid discharge elements included in each group are divided into a plurality of blocks, and
the liquid discharge elements are time-divisionally driven for each block o the plurality of blocks.

10. The substrate according to claim 1, further comprising a plurality of sub-heaters,
wherein each of the plurality of sub-heaters is arranged in correspondence with not less than one group of the plurality of groups.

11. The substrate according to claim 1, wherein an enable signal that defines drive timings of the plurality of liquid discharge elements is supplied to the first control signal line and the second control signal line, and
the drive timing of each of the plurality of groups is controlled by an output of a corresponding delay element among a plurality of delay elements including the first delay element, the second delay element, the third delay element, and the fourth delay element.

12. A liquid discharge head substrate comprising:
a plurality of liquid discharge elements divided into a plurality of groups; and
a first control signal line and a second control signal line, on each of which a terminal to which an enable signal that defines drive timings of the plurality of liquid discharge elements is supplied and a plurality of delay elements configured to delay propagation of the enable signal are arranged,
wherein the plurality of delay elements include a first delay element and second delay element arranged on the first control signal line, and a third delay element and a fourth delay element arranged on the second control signal line,
the plurality of groups include a first group whose drive timing is controlled by an output of the first delay element, a second group whose drive timing is controlled by an output of the second delay element and in which the number of included liquid discharge elements is smaller than in the first group, a third group whose drive timing is controlled by an output of the third delay element, and a fourth group whose drive timing is controlled by an output of the fourth delay element and in which the number of included liquid discharge elements is smaller than in the third group, and
the number of delay elements arranged between the terminal and the first delay element on the first control signal line and the number of delay elements arranged between the terminal and the third delay element on the second control signal line are different.

13. A liquid discharge head comprising a liquid discharge head substrate defined in claim 1, and a discharge port whose liquid discharge is controlled by the liquid discharge head substrate.

14. A liquid discharge apparatus comprising a liquid discharge head defined in claim 13, and a unit configured to supply, to the liquid discharge head, a driving signal for discharging a liquid.
